SEQUENCE LISTING (9 sequences)

SEQ ID NO: 1 - protein, 242 aa, Homo sapiens
MPVMRLFPCFLQLLAGLALPAVPPQQWALSAGNGSSEVEVVPFQEVWGRSYCRALERLVDVVSEYPSEVEHMFSPSCVSLLRCTGCCGDENLHCVPVETANVTMQLLKIRSGDRPSYVELTFSQHVRCECRHSPGRQSPDMPGDFRADAPSFLPPRRSLPMLFRMEWGCALTGSQSAVWPSSPVPEEIPRMHPGRNGKKQQRKPLREKMKPERRRPKGRGKRRREKQRPTDCHLCGDAVPRR

SEQ ID NO: 2 - protein, 131 aa, Homo sapiens
LPAVPPQQWALSAGNGSSEVEVVPFQEVWGRSYCRALERLVDVVSEYPSEVEHMFSPSCVSLLRCTGCCGDENLHCVPVETANVTMQLLKIRSGDRPSYVELTFSQHVRCECRPLREKMKPERCGDAVPRR

SEQ ID NO: 3 - protein, 152 aa, Homo sapiens
LPAVPPQQWALSAGNGSSEVEVVPFQEVWGRSYCRALERLVDVVSEYPSEVEHMFSPSCVSLLRCTGCCGDEDLHCVPVETANVTMQLLKIRSGDRPSYVELTFSQHVRCECRPLREKMKPERRRPKGRGKRRREKQRPTDCHLCGDAVPRR

SEQ ID NO: 4 - protein, 203 aa, Homo sapiens
LPAVPPQQWALSAGNGSSEVEVVPFQEVWGRSYCRALERLVDVVSEYPSEVEHMFSPSCVSLLRCTGCCGDENLHCVPVETANVTMQLLKIRSGDRPSYVELTFSQHVRCECRHSPGRQSPDMPGDFRADAPSFLPPRRSLPMLFRMEWGCALTGSQSAVWPSSPVPEEIPRMHPGRNGKKQQRKPLREKMKPERCGDAVPRR

SEQ ID NO: 5 - protein, 224 aa, Homo sapiens
LPAVPPQQWALSAGNGSSEVEVVPFQEVWGRSYCRALERLVDVVSEYPSEVEHMFSPSCVSLLRCTGCCGDENLHCVPVETANVTMQLLKIRSGDRPSYVELTFSQHVRCECRHSPGRQSPDMPGDFRADAPSFLPPRRSLPMLFRMEWGCALTGSQSAVWPSSPVPEEIPRMHPGRNGKKQQRKPLREKMKPERRRPKGRGKRRREKQRPTDCHLCGDAVPRR

SEQ ID NO: 6 - protein, 21 aa, Homo sapiens
RRPKGRGKRRREKQRPTDCHL

SEQ ID NO: 7 - protein, 72 aa, Homo sapiens
HSPGRQSPDMPGDFRADAPSFLPPRRSLPMLFRMEWGCALTGSQSAVWPSSPVPEEIPRMHPGRNGKKQQRK

SEQ ID NO: 8 - protein, 18 aa, Homo sapiens
HSPGRQSPDMPGDFRADA

SEQ ID NO: 9 - protein, 19 aa, Homo sapiens
PEEIPRMHPGRNGKKQQRK

(19) United States
(12) Patent Application Publication
(10) Pub. No.: US 2011/0294227 A1
(43) Pub. Date: Dec. 1, 2011

(54) METHOD FOR DETERMINING THE RISK OF PREECLAMPSIA USING PIGF-2 AND PIGF-3 MARKERS

(75) Inventors: Tarja Ahola, Turku (FI); Heini Frang, Lieto (FI); Teemu Korpimäki, Turku (FI); Pertti Hurskainen, Piispanristi (FI); Mark N. Bobrow, Lexington, MA (US); Jonathan B. Carmichael, Melville, NY (US)

(73) Assignees: PERKINELMER HEALTH SCIENCES, INC., Waltham, MA (US); WALLAC OY, Turku (FI); NTD LABORATORIES, INC., Melville, NY (US)

(21) Appl. No.: 13/130,086

(22) PCT Filed: Nov. 20, 2009
(86) PCT No.: PCT/US09/65355

§ 371 Date: Aug. 16, 2011

Related U.S. Application Data
(60) Provisional application No. 61/116,366, filed on Nov. 20, 2008.

(51) Int. Cl. G01N 21/64

(52) U.S. Cl. 436/501

(57) ABSTRACT

The present invention relates to a method for determining the risk of a pregnant woman developing pre-eclampsia. The method comprises i) determining the level of one or more biochemical markers in a sample obtained from a pregnant woman, and ii) comparing the level of the at least one biochemical marker in the sample with the level of the same biochemical marker in a control sample. A difference in the level of the biochemical marker in the sample relative to the control sample is indicative of an increased risk of developing pre-eclampsia. The isoform biochemical markers are preferably P1GF-2 and P1GF-3. The present invention relates also to a method for determining whether a pregnant woman has pre-eclampsia and as well as a kit for assessing the risk or presence of pre-eclampsia. In addition, the invention relates also to a computer program used in these determinations.

### BACKGROUND OF INVENTION

At least 126 million women give birth every year worldwide. Over 20 million of them experience a pregnancy related complication or illness. For example, hypertensive disorders such as pre-eclampsia (PE) affect more than 10% of all pregnancies and are a leading cause of maternal death. Adequate prenatal health care decreases the chances that such complications and illnesses will go unnoticed. Even so, currently no routine screens have been adopted for early detection of pre-eclampsia using maternal samples. If the development of PE, and in particular early onset PE, could be detected earlier, better outcomes, including severity reduction and even recovery could be possible in many cases. During the pregnancy, at an early or later stage, a reliable risk assessment method for developing PE or assessment of the presence of PE would decrease the potential for negative health outcome of the pregnant woman, the baby or both.

Many biological markers present in maternal samples are currently recognized as associated with pre-eclampsia. Placental growth factor (P1GF) is currently suggested for use in assessing the risk of a pregnant woman developing PE (Akolekar et al. (2008) maternal serum placental growth factor at 11+0 to 13+6 weeks of gestation in the prediction of pre-eclampsia. Ultrasound Obstet Gynecol 32:732-739). Although P1GF has received some acceptance as a reliable marker of pre-eclampsia, it is desirable to have alternative and additional markers characterized by greater specificity and predictive power.

### SUMMARY OF THE INVENTION

The invention described herein provides, in one aspect, a method for determining the risk of a pregnant woman developing pre-eclampsia. The method involves determining the level of one or more biochemical markers in a sample obtained from a pregnant woman, wherein at least one biochemical marker is a P1GF isoform selected from P1GF-2 and P1GF-3; comparing the level of the at least one biochemical marker in the sample with the level of the same biochemical marker in a control sample; wherein a difference in the level of the at least one biochemical marker in the sample relative to the control sample is indicative of an increased risk of developing pre-eclampsia.

In an embodiment, the level of PIGF-2 is determined. In this case an increased level of P1GF-2 in the sample relative to the control sample is indicative of an increased risk of developing pre-eclampsia.

In another embodiment, the level of P1GF-3 is determined. In this case decreased level of P1GF-3 in the subject sample relative to the control sample is indicative of an increased risk of developing pre-eclampsia.

In various embodiments, combinations of P1GF isoforms are employed. For example, P1GF-2 and P1GF-3 can be used when determining the risk of a pregnant woman developing pre-eclampsia. Other exemplary P1GF isoform combinations include P1GF-2 and P1GF-1; P1GF-3 and P1GF-1; P1GF-1, P1GF-2 and P1GF3.

In further embodiments, ratios of biochemical markers are employed when determining the risk of a pregnant woman developing pre-eclampsia. In a specific embodiment, the ratio of PIGF-2/PIGF-3 is determined. In another embodiment, the ratio of PIGF-2/PIGF-1 is determined. In both of these examples, a difference in the ratio in the subject sample relative to the control sample is indicative of an increased risk of developing pre-eclampsia.

In additional embodiments, P1GF-2 and/or P1GF-3 can be used in combination with one or more of biochemical markers of pre-eclampsia, hypertension, placental disorders and the like. In specific embodiment, one or more biochemical markers selected from PAPP-A, PAI-1, PAI-2, P1GF-1, P1GF-4, PP13, VEGF165b and ADAM-12 are used. Other biochemical markers useful for detecting pre-eclampsia also can be used in combination with P1GF-2, P1GF-3 and both P1GF-2 and P1GF-3. As a specific example, when P1GF-1 is used in such combination, the level of P1GF-1 in the subject sample relative to the control sample is indicative of an increased risk of developing pre-eclampsia.

In another embodiment, the methods for determining the risk of a pregnant woman developing pre-eclampsia includes using one or more biophysical markers of the pregnant woman. The determined biophysical markers are compared with the same biophysical marker in a control subject, wherein an increased or decreased measure of each biophysical marker in the pregnant woman relative to the control is indicative of an increased risk of developing pre-eclampsia. In one embodiment the biophysical marker is blood pressure. In another embodiment, the biophysical marker is uterine artery pulsatility index.

The methods described herein for determining the risk of a pregnant woman developing pre-eclampsia can be practiced using a sample obtained from the woman during the first or second trimester of pregnancy. In a specific embodiment, the sample is obtained during the first trimester. In another embodiment, the sample is obtained during the second trimester. In an embodiment, one or more samples can be obtained from the woman at one or more stages of pregnancy.

Also provided by the invention described herein is a method for determining whether a pregnant woman has pre-eclampsia. The method involves determining the level of one or more biochemical markers in a sample obtained from a pregnant woman, wherein at least one biochemical marker is a P1GF isoform selected from P1GF-2 and P1GF-3; comparing the level of the at least one biochemical marker in the sample with the level of the same biochemical marker in a control sample; wherein a difference in the level of the at least one biochemical marker in the subject sample relative to the control sample is indicative of pre-eclampsia.

In an embodiment of this method, at least one of the following observations are made: the level of PIGF-2 in a sample obtained from a subject is increased relative to the level of PIGF-2 in the control sample; and/or the level of PIGF-3 in a sample obtained from a subject is decreased relative to the level of PIGF-3 in the control sample.

In an embodiment, a difference in ratio of PIGF-2/PIGF-1 in a sample obtained from a subject relative to the control sample is indicative of an increased risk of developing pre-eclampsia. In another embodiment, a difference in the ratio of PIGF-2/PIGF-3 in a sample obtained from a subject relative to the control sample is indicative of an increased risk of developing pre-eclampsia.

In an embodiment, one or more samples can be obtained from the pregnant woman during first and/or second trimester of pregnancy, such as between weeks 20-40 of pregnancy.

Further provided by the invention described herein is a computer program which when executed on a computer causes the computer to perform a process for determining risk or presence of pre-eclampsia in a pregnant woman. The process can involve inputting a measurement of at least one biomarker obtained by: i) assaying a sample obtained from the pregnant woman for one or more biochemical markers, wherein at least one biochemical marker is selected from PIGF-2 and PIGF-3; ii) comparing the level of the one or more biochemical marker in the sample with the level of the same biochemical marker in a control sample, wherein a difference in level of the one or more biochemical marker in the sample relative to the control sample is indicative of pre-eclampsia, and iii) determining a quantitative estimate of pre-eclampsia risk based on the result of the comparing.

In an embodiment, the computer program can further involve use of at least one additional biochemical marker. In specific embodiments, the one or more biochemical markers can be selected from the group comprising PAPP-A, PAI-1, PAI-2, P1GF-1, VEGF165b, P1GF-4 and ADAM-12.

In a further embodiment, the computer program can involve inputting a measurement of at least one biomarker obtained by determining one or more biophysical markers of the subject; comparing the one or more biophysical markers of the subject with the same biophysical marker in a control subject, wherein an increased or decreased measure of the one or more biophysical marker in the subject relative to the control is indicative of an increased risk of developing pre-eclampsia, and determining a quantitative estimate of pre-eclampsia risk based on the result of the compared one of more biochemical marker and the compared one or more biophysical marker. In particular embodiments, the biophysical marker can be selected from blood pressure and uterine artery pulsatility index.

In an embodiment of the computer program, the process can also include determining the quantitative estimate of pre-eclampsia risk comprises determining the likelihood of pre-eclampsia using a multivariate analysis, and wherein the multivariate analysis comprises using levels of the biochemical markers and distribution parameters derived from a set of control reference data. In an embodiment, the multivariate analysis is a multivariate Gaussian analysis.

Additional provided by the technology described herein is computer program recording medium storing a computer program as is described above.

The invention described herein includes kits or commercial packages for assessing risk or presence of pre-eclampsia in a pregnant woman. In an embodiment, the kit provides i) at least two detectable binding partners, wherein each detectable binding partner binds specifically to an individual P1GF isoform selected from PIGF-1, PIGF-2 and PIGF-3.

In a specific embodiment, a kit provides i) a detectable binding partner that binds specifically to PIGF-2, and ii) a detectable binding partner that binds specifically to a P1GF isoform selected from P1GF-1 and PIGF-3.

In another specific embodiment, a kit provides i) a detectable binding partner that binds specifically to PIGF-3, and ii) a detectable binding partner that binds specifically to a P1GF isoform selected from P1GF-1 and PIGF-2.

In embodiments, the detectable binding partner is an antibody or antigen-binding fragment thereof.

In a further specific embodiment, a kit provides i) at least one antibody or an antigen-binding fragment thereof, that binds specifically to a P1GF isoform selected from PIGF-2 and PIGF-3; and ii) instructions for using the antibody or antigen-binding fragment in the determination.

In an embodiment the antibody or antigen-binding fragment thereof binds to the loop 3 structure of the P1GF isoform. In a specific embodiment, the antibody or antigen-binding fragment thereof binds to the sequence between amino acids 124 to 144 in mature PIGF-2 (SEQ ID NO:6) or to the sequence between amino acids 114 to 185 in mature PIGF-3 (SEQ ID NO:7). In specific embodiments, the antibody or antigen-binding fragment thereof binds to a P1GF-3 sequence selected from HSPGRQSPDMPGDFRADA (SEQ ID NO:8) and PEEIPRMHPGRNGKKQQRK (SEQ ID NO:9).

In the following text, the invention will be further described with the aid of a detailed description and with reference to some working examples.

### BRIEF DESCRIPTION OF THE DRAWINGS

FIG. 1 shows levels of P1GF-2, P1GF-3 and combined P1GF-1, P1GF-2 and P1GF-3 in maternal serum at 13 to 37 weeks of gestation.

FIG. 2 describes the results of a matched case-control study in which samples taken from pregnant, non-pre-eclamptic females (controls, represented by triangles in the illustration) and samples taken from pregnant females that later on in their pregnancy developed pre-eclampsia (cases, represented by crosses in the illustration) were measured with a method that detects P1GF-2 isoform.

FIG. 3 describes the results of a matched case-control study in which samples taken from pregnant, non-pre-eclamptic females (controls, represented by triangles in the illustration) and samples taken from pregnant females that later on in their pregnancy developed pre-eclampsia (cases, represented by crosses in the illustration) were measured with a method that detects P1GF-3 isoform.

FIG. 4 describes the amino acid sequences of the P1GF Family and relatives; in the precursor amino acids 1 to 18 represent the signal sequence (underlined); in the precursor amino acids 214 to 234, in P1GF-2 amino acids 124 to 144, and in P1GF-4, amino acids 196 to 216 represent the Heparin binding domain (italics); in the precursor amino acids 132 to 204; in P1GF-3 amino acids 114 to 185, and in P1GF-4 amino acids 114 to 185 represent a domain of unknown function (bold).

### DETAILED DESCRIPTION OF THE INVENTION

The present invention relates to methods for determining the risk of a pregnant woman developing pre-eclampsia, to methods for determining whether a pregnant woman has pre-eclampsia, as well as to antibodies and kits for assessing the risk or presence of pre-eclampsia. Also provided by the invention is a computer program used in these determinations.

Described herein is use of selective detection of at least one of the isoforms P1GF-2 and P1GF-3, optionally together with other biochemical markers including P1GF isoforms such as P1GF-1 and P1GF-4, and the comparison of the level of the at least one biochemical marker to a value obtained from a control sample. A difference in the level of the biochemical marker in the sample relative to control sample indicates the risk or presence of pre-eclampsia in the woman. The difference can be an increase or decrease in the level of the value, depending on the particular biomarker tested.

Previously published studies have shown that a lowered level of P1GF-1 indicates the development of pre-eclampsia. The measurement methods used in such studies appear to mainly detect P1GF-1, but in at least some cases, there is significant cross-reactivity with other P1GF isoforms (see Example 2). When the level of the isoforms P1GF-2 and P1GF-3 were selectively determined as is described herein, it was surprisingly found that the level of P1GF-2 was increased in the sample relative to the control sample. Additionally it was found that the level of P1GF-3 was decreased in the sample relative to the control sample.

As is described herein, it has now been recognized that measurement of a specific isoform of P1GF in a maternal sample can be used to better determine risk of a pregnant woman developing pre-eclampsia. Assay of a target P1GF isoform can provide more specific results in laboratory tests because background signal caused by the presence of non-target P1GF isoforms can be reduced or eliminated. The screening performance will thus be improved, as reflected by increased detection rates and lower false positive rates, relative to laboratory tests that employ non-selective P1GF detection. Also recognized is that a difference in the ratio of P1GF isoforms, for example, P1GF-2/P1GF-3 and/or P1GF-2/P1GF-1, in the subject sample relative to the control sample can be used as indicative of an increased risk of developing pre-eclampsia. Ratios of a P1GF isoform such as P1GF-2 or P1GF-3 and another biochemical marker can also be used if desired.

The selective detection of the isoforms P1GF-2 and/or P1GF-3 optionally together with another P1GF isoform, such as P1GF-1 or PIGF-4, or both, can be combined with any other suitable biochemical markers or other indicators used for assessing the risk of developing pre-eclampsia. Such biochemical markers are for example those selected from PAPP-A, PAI-1, PAI-2, P1GF-1, P1GF-4, PP13, VEGF165b and ADAM-12.

The selective detection of the isoforms P1GF-2 and/or P1GF-3 optionally together with another P1GF isoform can be combined also with any suitable biophysical markers for assessing the risk of developing pre-eclampsia. Such biochemical markers are for example blood pressure and uterine artery pulsatility index.

As used herein, the term “pre-eclampsia” means a disorder of pregnancy characterized in part by gestational hypertension and proteinuria. For previously normotensive women, PE is typically defined as gestational hypertension with proteinuria, and severe PE is typically defined as severe gestational hypertension with proteinuria. For women with chronic hypertension, superimposed PE is typically defined as the new development of proteinuria. Aspects of PE useful for making a diagnosis of PE can be classified according to guidelines set out by various medical organizations. For example, gestational hypertension, according to guidelines of the International Society for the Study of Hypertension in Pregnancy (Davey et al., Am. J. Obstet Gynecol; 158; 892098, 1988), is described as two recordings of diastolic blood pressure of 90 mmHg or higher at least 4 h apart, and severe hypertension as pressure of at least 110 mm Hg or higher at least 4 h apart or one recording of diastolic blood pressure of at least 120 mm Hg. Proteinuria is often described as excretion of 300 mg or more in 24 h or two readings of 2+ or higher on dipstick analysis of midstream or catheter urine specimens if no 24 h collection was available. Women are classified as previously normotensive or with chronic hypertension generally before 20 weeks gestation. Pre-eclampsia is understood and shall be defined herein to encompass and reside within a spectrum of pre-eclampsia disorders, including placental insufficiency, intrauterine growth retardation, early miscarriage, preterm birth, intrauterine death and eclampsia. Although not wishing to be bound by theory, it has been proposed that intrauterine growth retardation reflects an adaptation of the pregnant woman's body to cope with the condition of pre-eclampsia, which allows the fetus to survive. Early miscarriage and preterm birth, on the other hand, can reflect adaptation of the pregnant woman's body to cope with the condition of pre-eclampsia, which allow the woman to survive. In this context, intrauterine death would be a failure of this adaptation. Thus, the methods described herein for determining risk of pre-eclampsia include, and can also be used to determine risk of pre-eclampsia disorders on the pre-eclampsia spectrum.

According one embodiment of the invention, a method for determining the risk of a pregnant woman developing pre-eclampsia, involves
i) determining the level of one or more biochemical markers in a sample obtained from a pregnant woman, wherein at least one biochemical marker is a P1GF isoform selected from P1GF-2 and P1GF-3;
ii) comparing the level of the at least one biochemical marker in the sample with the level of the same biochemical marker in a control sample;
   wherein a difference in the level of the at least one biochemical marker in the sample relative to the control sample is indicative of an increased risk of developing pre-eclampsia.

The method according to this disclosure for determining the risk of a pregnant woman developing pre-eclampsia, or having pre-eclampsia, is an in vitro method. This means that the method is carried outside the body of the pregnant woman (also referred to herein as the patient or subject).

In instances where a pregnant individual is determined to have an increased risk of developing pre-eclampsia using a method as described herein, the individual can receive therapy or lifestyle advice from a health care provider. Although there is no widely used treatment for pre-eclampsia, various studies have shown the benefit of therapies such as anti-hypertensive drugs, such as magnesium sulphate, aspirin, diazepam, and phenytoin; and dietary supplements, such as vitamin D, calcium, and selenium.

A sample useful for carrying out the methods described herein generally includes tissues and fluids in which an isoform of P1GF is present. The sample can be any body fluid or tissue sample that contains the selected biochemical markers. Typically a conveniently obtained sample is a body fluid, such as blood and its fractions, such as serum and plasma, sputum or urine obtained from the pregnant woman. It is also possible to use a tissue sample obtained from the pregnant woman, or a cell obtained from the pregnant woman, including a cell which has been placed in or expanded in cell culture. Other exemplary biological samples useful for the methods described herein in amniotic fluid, a chorionic villus biopsy, a placental biopsy and cervicovaginal fluid. Further, samples that have been preserved, such as by freezing or drying (e.g. on blood card format), are suitable for use in the methods described herein. Example 1 describes use of maternal blood in the form of serum. The choice of sample can often depend on the assay formats available in a particular clinical laboratory for testing amounts of markers. For example, some assay formats lack sensitivity needed for assaying whole blood, such that a clinical laboratory opts for testing a fraction of blood, such as serum, or using dried blood.

In certain circumstances, biological samples can be collected on more than one occasion from a pregnant woman, for example, when her hypertensive and/or placental condition requires monitoring for development of pre-eclampsia due to a priori risk, presentation of symptoms and/or other factors. The methods for determining risk of pre-eclampsia described herein can also be used for monitoring a pregnant individual who is undergoing a therapy or treatment for a hypertensive and/or placental condition. If desired, testing of biochemical and/or biophysical markers can be carried out in a home setting, such as by using dipstick biochemical test formats and automated blood pressure machines for home use.

The determination of the P1GF isoforms and other biochemical markers can be carried out during the first trimester or the second trimester of the pregnancy, or during both of the trimesters. However, the ability to detect a high risk of developing pre-eclampsia within the first 12 weeks of pregnancy provides more time for a health care provider to provide prevention strategies for the pregnant woman. It is often desirable to complete a risk assessment early in pregnancy, to allow time for measures for preventing or retarding the PE condition to develop in the woman. Thus, according to one embodiment of the invention the sample is taken during the first trimester of the pregnancy. Typically this means the weeks 1 to 13 of the pregnancy. According to another embodiment of the invention the sample is taken during the second trimester of the pregnancy. Typically this means the weeks 14 to 26 of the pregnancy.

Pre-eclampsia can develop as early as 20 weeks of gestation and is generally considered “early pre-eclampsia” when it develops before about 32-34 weeks of gestation, and “late pre-eclampsia” when it develops after about 32-34 weeks of gestation. Early pre-eclampsia is associated with increased morbidity and thus is considered a more severe form of pre-eclampsia. The methods for determining the risk of PE described herein are useful for screening for “early pre-eclampsia” and “late pre-eclampsia.” As is described herein, for instance in Example 1, the methods for determining risk of pre-eclampsia are effective during less than 22 weeks of gestation, inclusive, and even less than 13 weeks of gestation. Thus, for use in the methods for detecting pre-eclampsia, a sample can be collected between about 11 and 37 weeks gestation, inclusive, including between about 11 and 20 weeks, inclusive, and more generally, prior to about 20 weeks, within first trimester after about 10 weeks, within second trimester and within third trimester. Although earlier testing is often a beneficial policy from a public health perspective, it is understood that collection of samples can sometimes be affected by practical considerations such as a woman delaying a visit to her health care provider until relatively later weeks of gestation.

The methods described herein can involve, in an embodiment, determining blood pressure of an individual. One or more of systolic blood pressure, diastolic blood pressure and mean arterial blood pressure of the pregnant individual can be used. Mean arterial pressure (MAP) refers to the average blood pressure over a cardiac cycle and is determined by the cardiac output (CO), systemic vascular resistance (SVR), and central venous pressure (CVP), using established procedures. A health care provider can use any method to measure the blood pressure of the pregnant individual, including, for example, palpation methods, auscultatory methods and oscillometric methods. Automated blood pressure measuring equipment also can be used. In an embodiment, the methods described herein also can involve determining uterine artery pulsatility index (PI). By “uterine artery pulsatility index” is meant an arterial blood-flow velocity waveform index designed to quantify the pulsatility or oscillations of the waveform. The PI has been found particularly useful in clinical cases in which there is diastolic flow reversal, i.e. bidirectional flow. The PI of the pregnant individual can be measured using any known method. For example, uterine artery Doppler ultrasonography can be performed via the transvaginal or transabdominal route. The uterine artery is first identified with the use of color Doppler ultrasonography. Pulsed-wave Doppler ultrasonography can then be used to obtain waveforms. Various indices can then be calculated. For example PI can be calculated as the peak systolic flow minus the end diastolic flow divided by the mean flow. Although not wishing to be bound by theory, there is evidence that pre-eclampsia is a consequence of failure of trophoblastic invasion of the maternal spiral arteries. Doppler ultrasound allows assessing the blood flow pattern in the maternal uterine arteries and identifying pregnancies with impaired trophoblastic invasion.

The methods described herein involve determining the level or amount of a P1GF isoform in a sample. The abbreviation “P1GF” means placental growth factor. PIGF was originally cloned from human term placenta cDNA library in 1991. PIGF has been detected also in other tissues such as heart, lung, muscle and adipose tissue. PIGF belongs to the vascular endothelial growth factor (VEGF) family of proteins. It has a moderate sequence similarity of about 50% to VEGF-A. Alternative splicing generates four isoforms differing in size of which P1GF-1 and PIGF-2 are believed to be the major isoforms. P1GF-1 (SEQ ID NO:2) contains 131 amino acids (MW MONOMER 14.7 kDa, dimer 29.4 kDa). PIGF-2 (SEQ ID NO:3) contains P1GF-1 and of 21 amino acid heparin binding site insertion (MW monomer 17.3 kDa, dimer 34.6 kDa). The length of the full length P1GF-2 protein is thus 152 amino acids. P1GF-3 (SEQ ID NO:4) contains P1GF-1 and 72 amino acid insertion near the C-terminus (MW=monomer 22.8 kDa, dimer 45.6 kDa). Hence, the length of the full length P1GF-3 protein is 203 amino acids. P1GF-4 (SEQ ID NO:5) contains P1GF-3 and 21 amino acid heparin binding site insertion (MW=monomer 26.2 kDa, dimer 52.4 kDa). The length of the full length PIGF-4 is thus 224 amino acids.

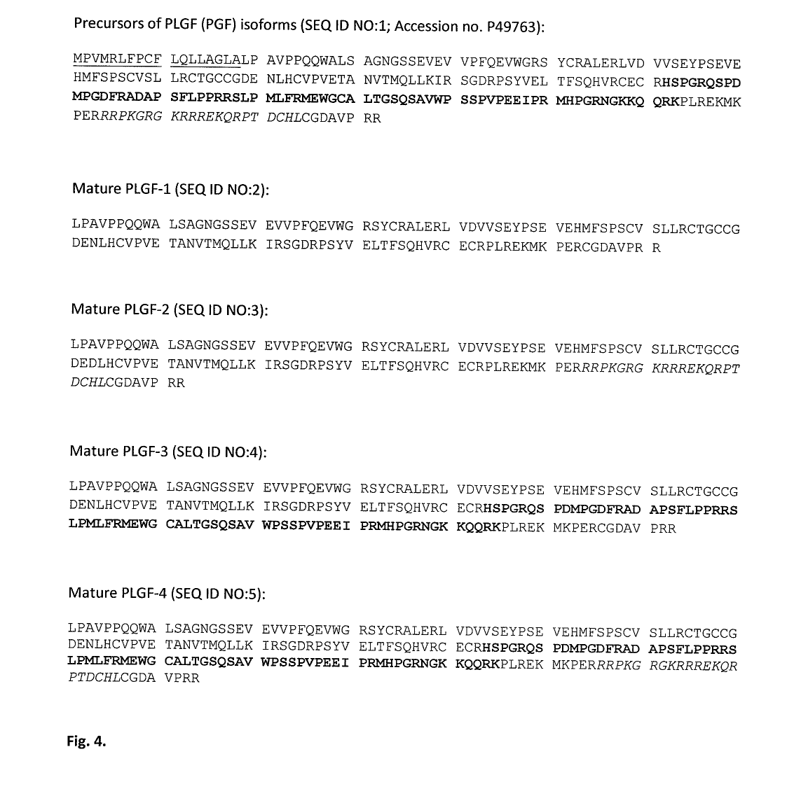

In FIG. 4 is summarized the amino acid sequences of the P1GF Family and relatives. In the precursor SEQ ID NO:1; (Accession no. P49763) amino acids 1 to 18 represent the signal sequence, amino acids 132 to 203 represent a domain of unknown function and in the precursor amino acids 214 to 234 represent the Heparin binding domain. In P1GF-2 (SEQ ID NO:3) amino acids 124 to 144 represent the Heparin binding domain (SEQ ID NO:6). In P1GF-3 (SEQ ID NO:4) amino acids 114 to 185 represent a domain of unknown function (SEQ ID NO:7), referred to herein as “loop 3”. In P1GF-4 (SEQ ID NO:5) amino acids 114 to 185 represent the loop 3 and amino acids 196 to 216 the Heparin binding domain.

By “determining the level of one or more biochemical markers in a sample obtained from a pregnant woman, wherein at least one biochemical marker is a P1GF isoform selected from P1GF-2 and P1GF-3” means that a selected isoform is determined by a method specifically assessing the level of the mentioned isoform in a sample obtained from the pregnant woman and from a control sample. The level or amount of a biochemical markers present in a sample can be determined using any assay format suitable for measuring proteins in biological samples. A common assay format for this purpose is the immunoassay, including, for example, enzyme immunoassays (EIA) such as enzyme multiplied immunoassay technique (EMIT), enzyme-linked immunosorbent assay (ELISA), IgM antibody capture ELISA (MAC ELISA), and microparticle enzyme immunoassay (MEIA); capillary electrophoresis immunoassays (CEIA); radioimmunoassays (RIA); immunoradiometric assays (IRMA); fluorescence polarization immunoassays (FPIA); dissociation-enhanced lanthanide fluorescent immunoassay (DELFIA) and chemiluminescence assays (CL).

A method of the present invention is exemplified herein by using an isoform specific DELFIA sandwich immunoassay. DELFIA is a heterogenous time-resolved fluorometric assay method that involves measuring a signal from a lanthanide chelate in a protocol employing an enhancement step. The method was used to measure the specific isoforms P1GF-1, P1GF-2 and P1GF-3. The capture antibody in the assay was biotinylated and the detection antibody europium labeled. In these assays can be used the P1GF isoform specific antibodies either from commercial monoclonal antibodies or custom made antibodies. To prepare antibodies that recognize P1GF-3 and do not substantially recognize P1GF-1 or P1GF-2, animals were immunized with antigens comprising peptides containing an amino acid sequence selected from loop 3 (amino acids HSPGRQSPDMPGDFRADAPSFLPPRRSLPMLFRMEWGCALTGSQSAVWPSS PVPEEIPRMHPGRNGKKQQRK; SEQ ID NO:7) of P1GF-3. Specific amino acid sequences that resulted in P1GF-3 selective antibodies (relative to P1GF-2 and P1GF-3) included HSPGRQSPDMPGDFRADA (SEQ ID NO:8) and PEEIPRMHPGRNGKKQQRK (SEQ ID NO:9). Commercially available P1GF-1, P1GF-2 or P1GF-3 proteins can be used as P1GF isoform standards. The measurement can be performed by a time-resolved fluorometer using the factory-set DELFIA protocol.

Typical assay formats for determining the amount of polypeptide and other biomarkers in a sample involve use of a control polypeptide, especially when quantitating levels of amounts of such polypeptides. Commercially available proteins, such as P1GF-1, P1GF-2, P1GF-3 and other biomarkers can be used as standards in assays measuring the level of biochemical markers. Alternatively, methods for expressing proteins, such as in prokaryotic and eukaryotic systems, and for synthesizing polypeptides are well known. Full length proteins and fragments thereof can be used as standards for quantitative determination of levels of biomarkers in a sample obtained from a pregnant woman. Nucleotide sequences of P1GF isoforms are known and published in scientific articles: P1GF-1: Maglione et al. 1991. Isolation of a human placenta cDNA coding for a protein related to the vascular permeability factor; P1GF-2: Hauser et al. A heparin-binding form of placental growth factor (P1GF-2) is expressed in human umbilical vein endothelial cells and in placenta; P1GF-3: Cao et al. (1997) Placental growth factor: identification and characterization of a novel isoform generated by RNA alternative splicing. Such sequences provide guidance for those skilled in the art for expressing P1GF polypeptides for use in methods described herein.

By “a control sample” is here meant a sample obtained from a subject being at the same trimester or gestational age of pregnancy, and wherein the pregnancy is confirmed to have a specific outcome in respect to pre-eclampsia. Typically a “control sample” has been confirmed to have not developed pre-eclampsia (see Examples herein), although use of a control sample confirmed to have developed pre-eclampsia is possible. The term is here defined to encompass one or more samples, so that a control sample can be a set of samples obtained from a population. The pregnant controls chosen can be matched to the pre-eclampsia cases by biophysical parameters, such as maternal age, body mass index, ethnicity and gestational age.

By “an increased risk of developing pre-eclampsia” is meant that the likelihood of the subject (pregnant woman) for developing pre-eclampsia is on a level, which is higher than in a control group of pregnant women not developing PE.

Briefly, an exemplary version of a method as described herein for determining risk of pre-eclampsia of a pregnant woman can be performed by taking a blood sample from the pregnant woman. The blood can be processed to prepare plasma or serum if desired. Assay for a selected subunit of PIGF would be carried out using a standard immunoassay using an antibody selective for a P1GF isoform, such as P1GF-2 or P1GF-3. An example is use of an enzyme linked immunosorbent assay (ELISA) in which intensity of colour development in a test sample is proportional to the concentration of marker present. Based on this test, the level of the PIGF isoform can be calculated. This level can be used in a risk algorithm independently, or in combination with levels of other markers, if desired. To design the risk algorithm, standard logistic regression analysis of a data set adjusted on the assumption of % prevalence of PE in the population can be used. To determine whether the amount of biochemical markers is greater than or less than normal, the normal amount of biochemical marker present in a maternal biological sample from a relevant population is determined. The relevant population can be defined based on any characteristics than can affect normal (unaffected) amounts of the markers. For determining risk of pre-eclampsia, the relevant population can be established on the basis of low risk for pre-eclampsia. Once the normal marker amounts are known, the determined marker amounts can be compared and the significance of the difference determined using standard statistical methods. When there is a statistically significant difference between the determined marker amount and the normal amount, there is a significant risk that the tested individual will develop pre-eclampsia.

The level of the selected biochemical marker in the sample is compared with the level of the same biochemical marker in a control sample. A difference in the level of biochemical marker in the sample relative to the control sample is indicative of an increased risk of developing pre-eclampsia. By a difference is meant a statistically significant difference in the values. By the presence of “increased or decreased levels” of any of the isoforms means that the level of any of the specific isoforms deviates statistically significantly from the level of the same isoform in a control sample being higher or lower than the level in the control sample.

To analyze the measurement results of a single sample in routine screening for pre-eclampsia, data of a control population is first needed. This data is obtained by measuring the selected P1GF isoforms from a large number of samples, preferably more than 100 samples per each week of pregnancy. The measured concentrations of the selected isoforms are then preferably log₁₀ transformed to make the distribution of the biological variation Gaussian. Subsequently, a median concentration and standard deviation for each selected isoform is determined for each pregnancy week in from the control data. Afterwards, the results of any single sample can be compared to the appropriate median concentrations to determine whether the concentrations of the selected isoforms differ from their normal values. This comparison can be used as a basis of calculating the patient risk for pre-eclampsia or as a basis of making a diagnosis of pre-eclampsia. Matched case-control studies can also be made to demonstrate the behaviour of biochemical markers such as the P1GF isoforms. In such studies, a control population that is matched by physiological parameters to the pre-eclampsia case population is used. Consequently, slightly different methods can be used to calculate the results of such study as compared to routine screening. Such a study is exemplified in Example 1.

According to this disclosure a pregnant woman is at increased risk of developing PE, if at least one of the following observations is made:

1. The level of P1GF-2 in the sample relative to the control sample is increased;
2. The level of P1GF-3 is decreased in the subject sample relative to the control sample;
3. The ratio of PIGF-2/PIGF-3 is determined, and a difference in ratio in the subject sample relative to the control sample is observed. Typically, the ratio is increased;
4. The ratio of PIGF-2/PIGF-1 is determined, and a difference in the ratio in the subject sample relative to the control sample is observed. Typically, the ratio is increased. The increased ratio is observed in particular during the second trimester of pregnancy.

The method as described herein can be combined with the determination of one or more biochemical markers is selected from PAPP-A, PAI-1, PAI-2, P1GF-1, PIGF-4, ADAM-12, PP13, and VEGF165b.

As used herein, the term “PAPP-A” means the metzincin metalloproteinase known as Pregnancy-associated plasma protein A and having an amino acid sequence homologous to GenBank accession number AAH78657. As used herein, the term “PP13” means placental protein 13, also known as galectin-13 having an amino acid sequence homologous to GenBank accession number NP_{—}037400. As used herein, the term “PAI-1” means Plasminogen activator inhibitor 1, also known as PAI and Endothelial plasminogen activator inhibitor, and having an amino acid sequence homologous to UniProt accession number P05121. As used herein, the term “PAI-2” means Plasminogen activator inhibitor 2, also known as Placental plasminogen activator inhibitor, Monocyte Arg-serpin and Urokinase inhibitor, and having an amino acid sequence homologous to UniProt accession number P05120. As used herein, the term ADAM-12 means Disintegrin and metalloproteinase domain-containing protein 12, also known as Meltrin-alpha, and having an amino acid sequence homologous to UniProt accession number O43184. As used herein, the term “VEGF165b” means vascular endothelial growth factor splice variant 165b and having an amino acid sequence homologous to UniProt accession number P15692-8.

When the one or more biochemical markers are compared with the same biochemical marker in a control subject, an increased or decreased measure of the biochemical marker in the pregnant woman relative to the control is indicative of an increased risk of developing pre-eclampsia.

The method as described herein can be combined also with the determination of one or more biophysical markers. The biophysical marker can be selected from blood pressure and uterine artery pulsatility index.

When the one or more biophysical markers are compared with the same biophysical marker in a control subject, an increased or decreased measure of the biophysical marker in the pregnant woman relative to the control is indicative of an increased risk of developing pre-eclampsia.

The detection method as described herein can be used also for diagnosing pre-eclampsia. Confirmation that a pregnant woman has pre-eclampsia can be typically carried out during second or third trimester of pregnancy, such as the 20th to 40th weeks of pregnancy; in some cases even before week 20.

According to one further embodiment the present invention a method for determining whether a pregnant woman has pre-eclampsia, comprises:

i) Determining the level of one or more biochemical markers in a sample obtained from a pregnant woman, wherein at least one biochemical marker is a P1GF isoform selected from P1GF-2 and P1GF-3;
ii) Comparing the level of the at least one biochemical marker in the sample with the level of the same biochemical marker in a control sample;
wherein a difference in the level of the at least one biochemical marker in the subject sample relative to the control sample is indicative of pre-eclampsia.

According to this disclosure a pregnant woman has PE, if at least one of the following observations is made:
1. The level of PIGF-2 in a sample obtained from a subject is increased relative to the level of PIGF-2 in the control sample;
2. The level of PIGF-3 in a sample obtained from a subject is decreased relative to the level of PIGF-3 in the control sample;
3. A difference in ratio of PIGF-2/PIGF-1 in a sample obtained from a subject relative to the control sample is observed;
4. A difference in the ratio of PIGF-2/PIGF-3 in a sample obtained from a subject relative to the control sample is observed.

Typically, both the ratio of PIGF-2/PIGF-1 and the ratio of PIGF-2/PIGF-3 are increased in a sample obtained from a subject relative to the control sample.

The determination whether a pregnant woman has PE is carried out during weeks 20-40 of pregnancy.

The method for determining whether a pregnant woman has pre-eclampsia can be combined with one or more biochemical markers selected from PAPP-A, PAI-1, PAI-2, PP13, VEGF165b, P1GF-1 and PIGF-4.

The method as described herein can be combined also with the determination of one or more biophysical markers, such as blood pressure and/or uterine artery pulsatility index.

According to one further embodiment the present invention a computer program which when executed on a computer causes the computer to perform a process for determining whether a pregnant woman is at risk of developing pre-eclampsia or determining the presence of the condition, wherein the process comprises:

inputting a measurement of at least one biochemical marker obtained by:
1) assaying a sample obtained from the pregnant woman for one or more biochemical markers, wherein at least one biochemical marker is selected from PIGF-2 and PIGF-3;
ii) comparing the level of the one or more biochemical marker in the sample with the level of the same biochemical marker in a control sample, wherein a difference in level of the one or more biochemical marker in the sample relative to the control sample is indicative of pre-eclampsia, and
iii) determining a quantitative estimate of pre-eclampsia risk based on the result of the comparing.

The computer program can further comprise assaying for at least one biochemical marker selected from the group comprising PAPP-A, PAI-1, PAI-2, ADAM-12, PP13, VEGF165b, P1GF-1 and PIGF-4.

The computer program can further comprise inputting a measurement of at least one biomarker obtained by determining one or more biophysical markers of the subject; comparing the one or more of the one or more biophysical markers of the subject with the same biophysical marker in a control subject, wherein an increased or decreased measure of the one or more one or more biophysical marker in the subject relative to the control is indicative of an increased risk of developing pre-eclampsia. Determining a quantitative estimate of pre-eclampsia risk based on the result of the compared one of more biochemical marker and the compared one or more biophysical marker.

The computer program can further comprise the use of a biophysical marker selected from blood pressure and uterine artery pulsatility index.

The determination of the quantitative estimate of pre-eclampsia risk comprises determining the likelihood of pre-eclampsia using a multivariate analysis. The multivariate analysis comprises using levels of the biochemical markers and distribution parameters derived from a set of control reference data. The multivariate analysis is a preferably a multivariate Gaussian analysis.

The present invention provides also a computer program recording medium storing the computer program as described herein.

The present invention provides a kit for assessing risk of developing pre-eclampsia or the presence of pre-eclampsia in a pregnant woman. In an embodiment, the kit can include i) at least two detectable binding partners, wherein each detectable binding partner binds specifically to an individual P1GF isoform selected from PIGF-1, PIGF-2 and PIGF-3. In another embodiment, the kit can include i) a detectable binding partner that binds specifically to PIGF-2, and ii) a detectable binding partner that binds specifically to a P1GF isoform selected from P1GF-1 and PIGF-3. In a further embodiment the kit can include i) a detectable binding partner that binds specifically to PIGF-3, and ii) a detectable binding partner that binds specifically to a P1GF isoform selected from P1GF-1 and PIGF-2. A detectable binding partner used in a kit as described herein can be, for example, an antibody or antigen-binding fragment thereof. Other binding partners useful for detecting protein-protein interactions also can be used.

The present invention provides also a kit for assessing risk of developing pre-eclampsia or the presence of pre-eclampsia in a pregnant woman. The kit can include i) at least one antibody or an antigen-binding fragment thereof, that binds specifically to a P1GF isoform selected from PIGF-2 and PIGF-3; and ii) instructions for using the antibody or antigen-binding fragment in the determination.

By instructions is meant guidelines how to carry out the determination by using the antibodies or antigen-binding fragments. Reagent volumes, incubation times, reaction conditions etc. can be provided in the instructions.

The antibody or antigen-binding fragment thereof can bind to a specific structure of an isoform, which can be a linear sequence of amino acids, a folded polypeptide aminio acid sequence, and any post-translational modification therein. In an embodiment, an antibody or antigen-binding fragment selective for P1GF-2 can binds to the sequence between amino acids 124 to 144 in mature PIGF-2 (SEQ ID NO:6). In an embodiment, an antibody or antigen-binding fragment selective for P1GF-3 can bind to the sequence between amino acids 114 to 185 in mature PIGF-3 (SEQ ID NO:7).

The methods described herein involve selectively detecting an isoform of P1GF using a laboratory test procedure. Such a test would employ an agent capable of selectively detecting an isoform of P1GF. Such an agent would not appreciably detect non-targeted P1GF isoform, intact P1GF and other molecules. An exemplary agent capable of selectively detecting an isoform of P1GF is an antibody selective for one of P1GF-1, P1GF-2, P1GF-3, P1GF-4 or another P1GF isoform. The assessment of the level of a selected isoform can be carried out for example by using an immunological method, where antibodies specifically bind to the selected isoform. An antibody can be selectively raised against the whole isoform and those antibodies that are specific against a specific structure of the isoform, such as loop 3 structure, are selected. Alternatively, antibodies can be raised against a specific structure of the isoform, such as loop 3 structure, of each isoform. Methods for preparing and characterizing antibodies are well known in the art (See, e.g. Harlow and Lane, 1988 Harlow, E. & Lane, D. Antibodies: A Laboratory Manual. Cold Spring Harbor Laboratory Press, New York, 1988, page 14 (incorporated herein by reference). The methods for generating mAbs generally begin along the same lines as those for preparing polyclonal antibodies. Briefly, a polyclonal antibody is prepared by immunizing an animal with one or more P1GF protein isoforms and collecting antisera from that immunized animal. A wide range of animal species can be used for the production of antisera. Typically the animal used for production of anti-antisera is rabbit, a mouse, a rat, a hamster, a guinea pig or a goat. MAbs can be readily prepared through use of well-known techniques, such as those exemplified in U.S. Pat. No. 4,196,265, incorporated herein by reference. Typically, the technique involves immunizing a suitable animal with a selected immunogen composition. The immunizing composition is administered in a manner effective to stimulate antibody producing cells. Rodents such as mice and rats are commonly used animals, however, the use of rabbit, sheep, or frog cells is also possible. Described herein are particular PLGF isoform-specific antibodies capable of distinguishing specific isoforms from each other.

The risk that a pregnant individual develops pre-eclampsia can be determined from biochemical marker amounts using statistical analysis based on clinical data collected in a patient population study. There are multiple statistical methods for combining parameters that characterize the pregnant individual, such as amounts of biochemical markers, to obtain a risk estimate. The likelihood method (Palomaki and Haddow, Am. J. Obstet. Gynecol. 156, 460-3 (1987)) and the linear discriminant function method (Norgarrd-Pedersen et al. Clin. Genet. 37, 35-43 (1990)) are commonly used for this purpose. As such, the methods described herein for determining risk can be based on use of well known statistical methods, in which a cutoff or a MoM is used to determine risk.

To outline an exemplary approach to risk determination, the basic principle of the likelihood method is that the population distributions for a parameter (such as the amount of a biochemical marker) are known for the ‘unaffected’ and ‘affected’ groups. Thus, for any given parameter (such as amount of marker and blood pressure reading), the likelihood of membership of the ‘unaffected’ and ‘affected’ groups can be calculated. The likelihood is calculated as the Gaussian height for the parameter based on the population mean and standard deviation. The ‘likelihood ratio’ is the ratio of the heights calculated using ‘unaffected’ and ‘affected’ population parameters, and is an expression of the increased risk of having a disorder, with respect to a prior risk. A woman's prior odds (which is a statistical expression related to prior risk, as is described herein below) for having pre-eclampsia or carrying a fetus with a chromosomal abnormality can be calculated using a formula derived by clinical population studies using known methods. These prior odds can be modified using the likelihood ratio to derive the posterior odds that can be used for the pre-eclampsia risk estimate. A detailed description of use of the likelihood method for predicting risk that a fetus has a chromosomal abnormality can be applied to predicting risk of pre-eclampsia and is set forth, for example, in “Screening for Down's Syndrome,” ed. J. G. Grudzinskas, T. Chard, M. Chapman and H. Cuckle; Published by Cambridge University Press, 1994). It is also possible to use observed distributions of likelihood ratios for determining risk using the methods described herein (see, for example, Spencer et al. Ann. Clin. Biochem., 29, 506-18 (1992)).

As an example of an approach for determining a risk that a pregnant woman develops pre-eclampsia, samples can be collected from a population of women known to have had pre-eclampsia. These samples are analyzed to determine the level of one or more P1GF isoforms. The determined level of P1GF isoform(s) would typically then be converted to a multiple of the expected normal median (MoM) specific to a pregnancy of the same gestational age, maternal weight, ethnicity, smoking status, method of conception and parity. Well known statistical regression approaches would then be used for risk calculations (see, for example Draper et al. Applied Regression Analysis (3th ed.) Wiley: New York, N.Y., 1998 and Cuckle HS et al., Estimating a woman's risk of having a pregnancy associated with Down's syndrome using her age and serum alphafetoprotein level. Br. J Obstet Gynacol 1987; 94:387-402; and other references above).

Previous reports have indicated that the level of P1GF in maternal blood can be used as a predictor of Down syndrome. It is therefore expected that detection of one or more specific isoforms of P1GF in a maternal sample can be used for detecting fetal chromosomal abnormalities.

The following numbered paragraphs each succinctly define one or more exemplary variations of the invention:

1. A method for determining the risk of a pregnant woman developing pre-eclampsia, comprising:
i) determining the level of one or more biochemical markers in a sample obtained from a pregnant woman, wherein at least one biochemical marker is a P1GF isoform selected from P1GF-2 and P1GF-3;
ii) comparing the level of the at least one biochemical marker in the sample with the level of the same biochemical marker in a control sample;
wherein a difference in the level of the at least one biochemical marker in the sample relative to the control sample is indicative of an increased risk of developing pre-eclampsia.
2. The method according to paragraph 1, wherein the level of PIGF-2 is determined, and wherein an increased level of P1GF-2 in the sample relative to the control sample is indicative of an increased risk of developing pre-eclampsia.
3. The method according to paragraph 1 or 2, wherein the level of P1GF-3 is determined, and wherein a decreased level of P1GF-3 in the subject sample relative to the control sample is indicative of an increased risk of developing pre-eclampsia.
4. The method according to any one of paragraphs 1 to 3, wherein a difference in the ratio of PIGF-2/PIGF-3 is determined, and wherein a difference in ratio in the subject sample relative to the control sample is indicative of an increased risk of developing pre-eclampsia.
5. The method according to any of paragraphs 1 to 4, wherein the level of PIGF-3 is determined, and wherein a decreased level of P1GF-3 in the subject sample relative to the control sample is indicative of an increased risk of developing pre-eclampsia.
6. The method according to any one of paragraphs 1 to 5, wherein the level of P1GF-2 is determined, and wherein an increased level of P1GF-2 in the subject sample relative to the control sample is indicative of an increased risk of developing pre-eclampsia.
7. The method according to any one of paragraphs 1 to 6, wherein at least one biochemical marker is selected from PAPP-A, PAI-1, PAI-2, P1GF-1 and ADAM-12.
8. The method according to any one of paragraph 1 to 7, wherein the level of P1GF-1 is determined, and wherein a decreased level of P1GF-1 in the subject sample relative to the control sample is indicative of an increased risk of developing pre-eclampsia.
9. The method according to any one of paragraphs 1 to 8, wherein the ratio of PIGF-2/PIGF-1 is determined, and wherein a difference in the ratio in the subject sample relative to the control sample is indicative of an increased risk of developing pre-eclampsia.
10. The method according to any one of paragraphs 1 to 9, wherein a sample is obtained from a subject during the first trimester of pregnancy.
11. The method according to any one of paragraphs 1 to 10, wherein a sample is obtained from a subject during the second trimester of pregnancy.
12. The method according to any one of paragraphs to 11, further comprising determining one or more biophysical markers of the pregnant woman, comparing each of the one or more biophysical markers with the same biophysical marker in a control subject, wherein an increased or decreased measure of each biophysical marker in the pregnant woman relative to the control is indicative of an increased risk of developing pre-eclampsia.
13. The method of according to any one of paragraphs 1 to 12, wherein the biophysical marker is selected from blood pressure and uterine artery pulsatility index.
14. A method for determining whether a pregnant woman has pre-eclampsia, comprising:
i) determining the level of one or more biochemical markers in a sample obtained from a pregnant woman, wherein at least one biochemical marker is a P1GF isoform selected from P1GF-2 and P1GF-3;
ii) comparing the level of the at least one biochemical marker in the sample with the level of the same biochemical marker in a control sample;
wherein a difference in the level of the at least one biochemical marker in the subject sample relative to the control sample is indicative of pre-eclampsia.
15. The method according to paragraph 14, wherein at least one of the following observations are made:
the level of PIGF-2 in a sample obtained from a subject is increased relative to the level of PIGF-2 in the control sample; and
the level of PIGF-3 in a sample obtained from a subject is decreased relative to the level of PIGF-3 in the control sample.
16. The method according to paragraph 14 or 15, wherein a difference in ratio of PIGF-2/PIGF-1 in a sample obtained from a subject relative to the control sample is indicative of an increased risk of developing pre-eclampsia.
17. The method according to any one of paragraphs 14 to 16, wherein a difference in the ratio of PIGF-2/PIGF-3 in a sample obtained from a subject relative to the control sample is indicative of an increased risk of developing pre-eclampsia.
18. The method according to any one of paragraphs 14 to 17, wherein a sample is obtained from the pregnant woman during weeks 20-40 of pregnancy.
19. A computer program which when executed on a computer causes the computer to perform a process for determining risk or presence of pre-eclampsia in a pregnant woman, the process comprising:
inputting a measurement of at least one biomarker obtained by:
1) assaying a sample obtained from the pregnant woman for one or more biochemical markers, wherein at least one biochemical marker is selected from PIGF-2 and PIGF-3;
ii) comparing the level of the one or more biochemical marker in the sample with the level of the same biochemical marker in a control sample, wherein a difference in level of the one or more biochemical marker in the sample relative to the control sample is indicative of pre-eclampsia, and
iii) determining a quantitative estimate of pre-eclampsia risk based on the result of the comparing.
20. The computer program according to paragraph 19, further comprising assaying for at least one biochemical marker selected from the group comprising PAPP-A, PAI-1, PAI-2, P1GF-1 and ADAM-12.
21. The computer program according to paragraph 19 or 20, further comprising inputting a measurement of at least one biomarker obtained by determining one or more biophysical markers of the subject; comparing the one or more biophysical markers of the subject with the same biophysical marker in a control subject, wherein an increased or decreased measure of the one or more biophysical marker in the subject relative to the control is indicative of an increased risk of developing pre-eclampsia, and determining a quantitative estimate of pre-eclampsia risk based on the result of the compared one of more biochemical marker and the compared one or more biophysical marker.
22. The computer program according to any one of paragraphs 19 to 21, wherein the biophysical marker is selected from blood pressure and uterine artery pulsatility index.
23. The computer program according to any of paragraphs 19 to 22, wherein determining the quantitative estimate of pre-eclampsia risk comprises determining the likelihood of pre-eclampsia using a multivariate analysis, and wherein the multivariate analysis comprises using levels of the biochemical markers and distribution parameters derived from a set of control reference data.
24. A computer program according to any one of paragraphs 19 to 23, wherein said multivariate analysis is a multivariate Gaussian analysis.
25. A computer program recording medium storing a computer program according to any one of paragraphs 19 to 24.
26. A kit for assessing risk or presence of pre-eclampsia in a pregnant woman, comprising
i) at least two detectable binding partners, wherein each detectable binding partner binds specifically to an individual P1GF isoform selected from PIGF-1, PIGF-2 and PIGF-3.
27. The kit according to paragraph 26, comprising:
i) a detectable binding partner that binds specifically to PIGF-2, and
ii) a detectable binding partner that binds specifically to a P1GF isoform selected from P1GF-1 and PIGF-3.
28. The kit according to paragraph 26 or 27, comprising:
i) a detectable binding partner that binds specifically to PIGF-3, and
ii) a detectable binding partner that binds specifically to a P1GF isoform selected from P1GF-1 and PIGF-2.
29. The kit according to any one of paragraphs 26 to 28, wherein the detectable binding partner is an antibody or antigen-binding fragment thereof
30. A kit for assessing risk and presence of pre-eclampsia in a pregnant woman, comprising
i) at least one antibody or an antigen-binding fragment thereof, that binds specifically to a P1GF isoform selected from PIGF-2 and PIGF-3;
ii) instructions for using the antibody or antigen-binding fragment in the determination.
31. The kit according to any one of paragraphs 26 to 30, wherein the antibody or antigen-binding fragment thereof binds to the loop 3 structure of the P1GF isoform.
32. The kit according to any one of paragraphs 26 to 31, wherein the antibody or antigen-binding fragment thereof binds to the sequence between amino acids 124 to 144 in mature PIGF-2 (SEQ ID NO:6) or to the sequence between amino acids 114 to 185 in mature PIGF-3 (SEQ ID NO:7).
33. The kit according to any one of paragraphs 26 to 32, wherein the antibody or antigen-binding fragment thereof binds to a P1GF-3 sequence selected from HSPGRQSPDMPGDFRADA (SEQ ID NO:8) and PEEIPRMHPGRNGKKQQRK (SEQ ID NO:9).

### EXAMPLES

### Example 1

This example describes that the level of P1GF-2 in maternal serum is increased in subjects who develop pre-eclampsia while the level of P1GF-3 in maternal serum is decreased in subjects who develop pre-eclampsia.

P1GF-isoform specific DELFIA sandwich assays were developed for measuring (a) P1GF-2; (b) P1GF-3 and (c) the combination of P1GF-1, P1GF-2 and P1GF-3.

P1GF isoforms were measured in serum obtained from pregnant women who subsequently developed pre-eclampsia and pregnant women unaffected by pre-eclampsia. Two blood samples were drawn from each woman: one during 1^{st} trimester and the second during 2^{nd} trimester of pregnancy. The blood tubes were centrifuged and serum was collected and aliquoted. These aliquots were stored at −20° C. The unaffected pregnancy controls chosen were matched to the pre-eclampsia pregnancy cases by biophysical parameters such as maternal age, body mass index, ethnicity and gestational age. P1GF-2 and P1GF-3 concentrations were measured in separate assays from eight different pre-eclampsia case samples and 16 matched control samples. The statistical analysis was done from these results.

In these assays the P1GF isoform specific antibodies were either commercial monoclonal antibodies or custom made antibodies. The capture antibody in the assay was biotinylated and the detection antibody was labeled with DELFIA europium chelate. 0.2 μg of biotinylated isoform specific antibody in 200 μl volume was incubated in streptavidin coated microtitration plates at 25° C. for 30 min. After washing, the 100 μl of serum pregnancy sample or P1GF standard was added and incubated for 2 hours. P1GF standards were commercial P1GF-1, P1GF-2 or P1GF-3 proteins. Wells were washed again and 0.2 μg of the Eu-anti-P1GF in 200 μl volume was added and incubated for 1 hour. Enhancement solution was added after wells were washed to develop the Eu signal. The measurement s was performed by a time-resolved fluorometer (Victor 2) at 615 nm using the factory-set DELFIA Eu protocol.

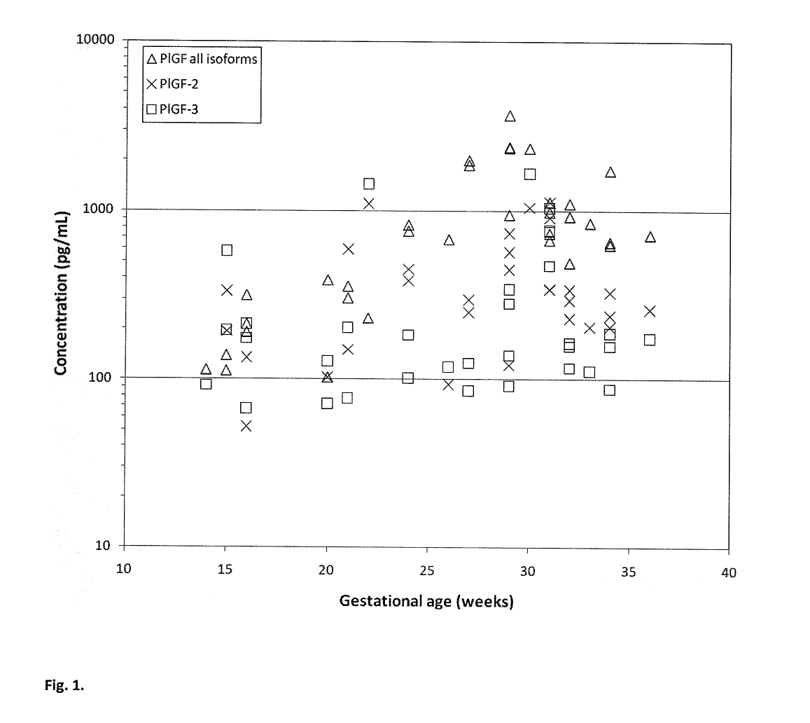

FIG. 1 shows the concentration of (a) P1GF-2 as “X”; (b) P1GF-3 as squares; and (c) P1GF-1, P1GF-2 and P1GF-3 as triangles. The concentration (pg/ml serum) P1GF isoform measured in each case increases as pregnancy progresses in women unaffected by pre-eclampsia, until about week 30, after which the concentrations eventually start to decline.

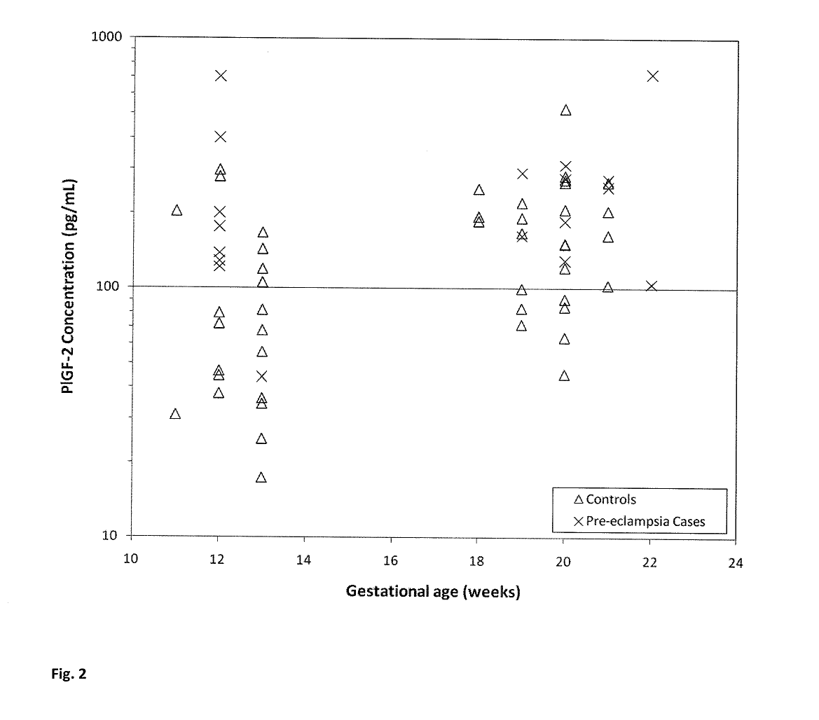

FIG. 2 describes the results of a matched case-control study in which samples taken from pregnant, non-pre-eclamptic females (controls, represented by triangles in the illustration) and samples taken from pregnant females that later on in their pregnancy developed pre-eclampsia (cases, represented by crosses in the illustration) were measured with a method that detects P1GF-2 isoform. The controls chosen were matched to the cases by their biophysical parameters (maternal age, body mass index, ethnicity and gestational age). Visual inspection of the results indicates that the concentrations measured from the case samples were elevated as compared to the control samples during both the 1^{st} and the 2^{nd} trimester of pregnancy.

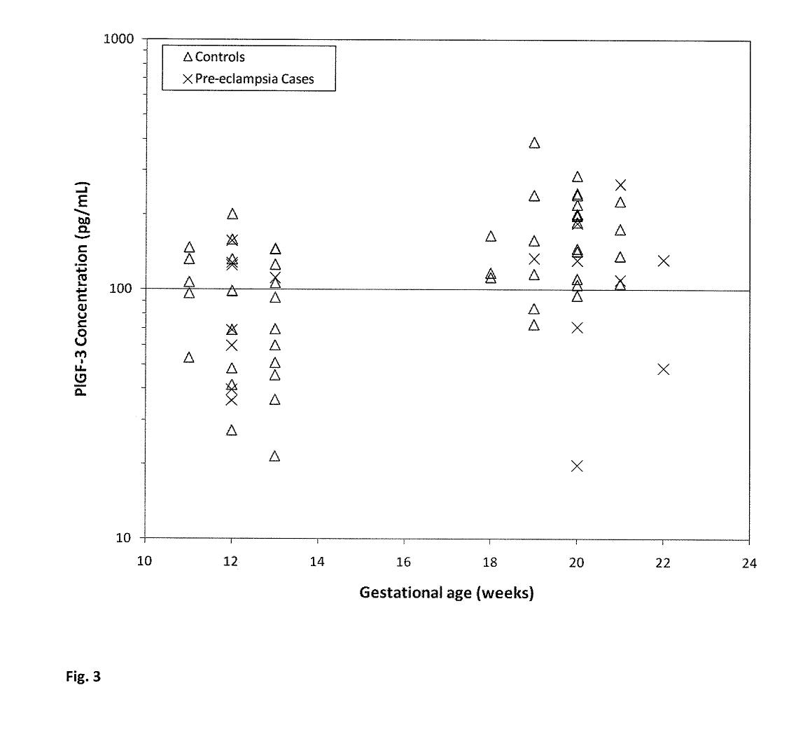

FIG. 3 describes the results of a matched case-control study in which samples taken from pregnant, non-pre-eclamptic females (controls, represented by triangles in the illustration) and samples taken from pregnant females that later on in their pregnancy developed pre-eclampsia (cases, represented by crosses in the illustration) were measured with a method that detects P1GF-3 isoform. The controls chosen were matched to the cases by their biophysical parameters (maternal age, body mass index, ethnicity and gestational age). Visual inspection of the results indicates that the concentrations measured from the case samples were essentially the same as compared to the control samples during the 1^{st} trimester of pregnancy, but clearly lower as compared to the control samples during the 2^{nd} trimester of pregnancy.

When analyzing the results of the matched case-control study, the measured concentrations of P1GF-2 and P1GF-3 isoforms were log₁₀ transformed to make the distribution of the biological variation Gaussian. Then, the medians, averages and standard deviations of the log₁₀ concentrations of the P1GF-2 and P1GF-3 isoforms in the samples of the pre-eclampsia case and control populations were calculated separately for the 1^{st} (gestational age 1-13 weeks) and 2^{nd} (gestational age 14-26 weeks) trimesters. Finally it was calculated how many multiples of the standard deviation of the control population the median of the pre-eclampsia case population differed from the median of the control population. The results of these calculations are summarized in Tables 1A (P1GF-2) and 1B (P1GF-3).

TABLE 1A

| | Log₁₀ of PlGF-2 Concentration | | | | | | | |
|---|---|---|---|---|---|---|---|---|
| | 1st trimester of pregnancy | | | | 2nd trimester of pregnancy | | | |
| | (weeks 1-13) | | | | (weeks 14-26) | | | |
| | | | | Difference | | | | Difference |
| | | | | (xSD of | | | | (xSD of |
| | Median | Average | SD | controls) | Median | Average | SD | controls) |
| Controls | 1.86 | 1.92 | 0.447 | | 2.23 | 2.19 | 0.247 | |
| PE | 2.20 | 2.25 | 0.360 | −0.761 | 2.42 | 2.37 | 0.236 | −0.769 |

TABLE 1B

| | Log₁₀ of PlGF-3 Concentration | | | | | | | |
|---|---|---|---|---|---|---|---|---|
| | 1st trimester of pregnancy | | | | 2nd trimester of pregnancy | | | |
| | (weeks 1-13) | | | | (weeks 14-26) | | | |
| | | | | Difference | | | | Difference |
| | | | | (xSD of | | | | (xSD of |
| | Median | Average | SD | controls) | Median | Average | SD | controls) |
| Controls | 1.98 | 1.90 | 0.263 | | 2.21 | 2.20 | 0.178 | |
| PE | 1.95 | 1.90 | 0.245 | 0.114 | 2.12 | 2.01 | 0.321 | 0.506 |

The results showed that the median concentration of P1GF-2 isoform in the samples from the pre-eclampsia population was higher than in the samples from the control population during both the 1^{st} and the 2^{nd} trimesters of pregnancy. This difference in medians in both trimesters was about 0.8 times the standard deviation of the control population results and it was concluded that the concentration of P1GF-2 isoform in blood would be a more useful measurand when predicting the risk of an individual for developing pre-eclampsia later on in pregnancy, as has been done before with other measurands (Akolekar et al. (2008)).

The median concentration of P1GF-3 isoform in the samples from the pre-eclampsia population was lower than in the samples from the control population during the 2^{nd} trimester of pregnancy. This difference in medians was about 0.5 times the standard deviation of the control population results. The difference of medians between the pre-eclampsia and control populations during the 1^{st} trimester of pregnancy was too small to be significant. It was concluded that the concentration of P1GF-3 isoform in blood during the 2^{nd} trimester is a useful measurand when predicting the risk of an individual for developing pre-eclampsia later on in pregnancy.

### Example 2

This method shows that a commercially available assay for P1GF-1 has cross-reactivity with other P1GF isoforms.

P1GF-1 was assayed using a commercial DELFIA Xpress P1GF method (PerkinElmer). Samples were prepared to contain known amounts of purified recombinant P1GF isoforms, including recombinant P1GF-1 (non-glycosylated). It was observed as expected that the P1GF-1 antibody provided with the DELFIA Xpress kit was highest with P1GF-1 (Table 2). However, significant cross-reactivity to the P1GF-2 isoform and some cross-reactivity to the P1GF-3 isoform were also observed. Thus this method mainly detects P1GF-1, but not specifically.

Similar results have been observed by other manufacturers with their current P1GF-1 methods. For example, R&D Systems reports in their method instructions a 50% cross-reactivity with P1GF-2 as measured against standards prepared from P1GF-1 by their Quantikine Human P1GF ELISA kit. Roche reports in their method instructions a 28% cross-reactivity with P1GF-2 as measured against standards prepared from P1GF-1 by their Elecsys P1GF assay.

TABLE 2
DELFIA Xpress PlGF Assay cross-reactivity:

| | Tested | Observed |
|---|---|---|
| | concentration | cross-reactivity |
| Tested substance | (pg/mL) | (%) |
| PlGF-1 (glycosylated) | 5000 | 33 |
| PlGF-2 (glycosylated) | 5000 | 16 |
| PlGF-3 (non- | 5000 | 5 |
| glycosylated) | | |

1. A method for determining the risk of a pregnant woman developing pre-eclampsia, comprising:
i) determining selectively the level of one or more biochemical markers in a sample obtained from a pregnant woman, wherein at least one biochemical marker is a P1GF isoform selected from P1GF-2 and P1GF-3;
ii) comparing the level of the at least one biochemical marker in the sample with the level of the same biochemical marker in a control sample;
wherein a difference in the level of the at least one biochemical marker in the sample relative to the control sample is indicative of an increased risk of developing pre-eclampsia.

2. The method according to claim 1, wherein the level of PIGF-2 is determined, and wherein an increased level of P1GF-2 in the sample relative to the control sample is indicative of an increased risk of developing pre-eclampsia.

3. The method according to claim 2, wherein the level of P1GF-3 is determined, and wherein a decreased level of P1GF-3 in the subject sample relative to the control sample is indicative of an increased risk of developing pre-eclampsia.

4. The method according to claim 1, wherein a difference in the ratio of PIGF-2/PIGF-3 is determined, and wherein a difference in ratio in the subject sample relative to the control sample is indicative of an increased risk of developing pre-eclampsia.

5. The method according to claim 1, wherein the level of PIGF-3 is determined, and wherein a decreased level of P1GF-3 in the subject sample relative to the control sample is indicative of an increased risk of developing pre-eclampsia.

6. The method according to claim 5, wherein the level of P1GF-2 is determined, and wherein an increased level of P1GF-2 in the subject sample relative to the control sample is indicative of an increased risk of developing pre-eclampsia.

7. The method according to any one of claims 1 to 6, wherein at least one biochemical marker is selected from PAPP-A, PAI-1, PAI-2, P1GF-1 and ADAM-12.

8. The method according to claim 7, wherein the level of P1GF-1 is determined, and wherein a decreased level of P1GF-1 in the subject sample relative to the control sample is indicative of an increased risk of developing pre-eclampsia.

9. The method according to claim 1, wherein the ratio of PIGF-2/PIGF-1 is determined, and wherein a difference in the ratio in the subject sample relative to the control sample is indicative of an increased risk of developing pre-eclampsia.

10. The method according to claim 1, wherein a sample is obtained from a subject during the first trimester of pregnancy.

11. The method according to claim 1, wherein a sample is obtained from a subject during the second trimester of pregnancy.

12. The method according to claim 1, further comprising determining one or more biophysical markers of the pregnant woman, comparing each of the one or more biophysical markers with the same biophysical marker in a control subject, wherein an increased or decreased measure of each biophysical marker in the pregnant woman relative to the control is indicative of an increased risk of developing pre-eclampsia.

13. The method of claim 12, wherein the biophysical marker is selected from blood pressure and uterine artery pulsatility index.

14. A method for determining whether a pregnant woman has pre-eclampsia, comprising:
i) determining selectively the level of one or more biochemical markers in a sample obtained from a pregnant woman, wherein at least one biochemical marker is a P1GF isoform selected from P1GF-2 and P1GF-3;
ii) comparing the level of the at least one biochemical marker in the sample with the level of the same biochemical marker in a control sample;
wherein a difference in the level of the at least one biochemical marker in the subject sample relative to the control sample is indicative of pre-eclampsia.

15. The method according to claim 14, wherein at least one of the following observations are made:
the level of PIGF-2 in a sample obtained from a subject is increased relative to the level of PIGF-2 in the control sample; and
the level of PIGF-3 in a sample obtained from a subject is decreased relative to the level of PIGF-3 in the control sample.

16. The method according to claim 14 or 15, wherein a difference in ratio of PIGF-2/PIGF-1 in a sample obtained from a subject relative to the control sample is indicative of an increased risk of developing pre-eclampsia.

17. The method according to claim 14 or 15, wherein a difference in the ratio of PIGF-2/PIGF-3 in a sample obtained from a subject relative to the control sample is indicative of an increased risk of developing pre-eclampsia.

18. The method according to claim 14, wherein a sample is obtained from the pregnant woman during weeks 20-40 of pregnancy.

19. A computer program which when executed on a computer causes the computer to perform a process for determining risk or presence of pre-eclampsia in a pregnant woman, the process comprising:
inputting a measurement of at least one biomarker obtained by:
1) assaying a sample obtained from the pregnant woman for one or more biochemical markers, wherein at least one biochemical marker is selected from PIGF-2 and PIGF-3;
ii) comparing the level of the one or more biochemical marker in the sample with the level of the same biochemical marker in a control sample, wherein a difference in level of the one or more biochemical marker in the sample relative to the control sample is indicative of pre-eclampsia, and
iii) determining a quantitative estimate of pre-eclampsia risk based on the result of the comparing.

20. The computer program according to claim 19, further comprising assaying for at least one biochemical marker selected from the group comprising PAPP-A, PAI-1, PAI-2, P1GF-1 and ADAM-12.

21. The computer program according to claim 19 or 20, further comprising inputting a measurement of at least one biomarker obtained by determining one or more biophysical markers of the subject; comparing the one or more biophysical markers of the subject with the same biophysical marker in a control subject, wherein an increased or decreased measure of the one or more biophysical marker in the subject relative to the control is indicative of an increased risk of developing pre-eclampsia, and determining a quantitative estimate of pre-eclampsia risk based on the result of the compared one of more biochemical marker and the compared one or more biophysical marker.

22. The computer program according to claim 21, wherein the biophysical marker is selected from blood pressure and uterine artery pulsatility index.

23. The computer program according to claim 19, wherein determining the quantitative estimate of pre-eclampsia risk comprises determining the likelihood of pre-eclampsia using a multivariate analysis, and wherein the multivariate analysis comprises using levels of the biochemical markers and distribution parameters derived from a set of control reference data.

24. A computer program according to claim 22, wherein said multivariate analysis is a multivariate Gaussian analysis.

25. A computer program recording medium storing a computer program according to claim 19.

26. A kit for assessing risk or presence of pre-eclampsia in a pregnant woman, comprising:
i) at least two detectable binding partners, wherein each detectable binding partner binds specifically to an individual P1GF isoform selected from PIGF-1, PIGF-2 and PIGF-3.

27. The kit according to claim 26, comprising:
i) a detectable binding partner that binds specifically to PIGF-2, and
ii) a detectable binding partner that binds specifically to a P1GF isoform selected from P1GF-1 and PIGF-3.

28. The kit according to claim 26, comprising:
i) a detectable binding partner that binds specifically to PIGF-3, and
ii) a detectable binding partner that binds specifically to a P1GF isoform selected from P1GF-1 and PIGF-2.

29. The kit according to any one of claims 26 to 28, wherein the detectable binding partner is an antibody or antigen-binding fragment thereof.

30. A kit for assessing risk and presence of pre-eclampsia in a pregnant woman, comprising:
i) at least one antibody or an antigen-binding fragment thereof, that binds specifically to a P1GF isoform selected from PIGF-2 and PIGF-3;
ii) instructions for using the antibody or antigen-binding fragment in the determination.

31. The kit according to claim 26 or 30, wherein the antibody or antigen-binding fragment thereof binds to the loop 3 structure of the P1GF isoform.

32. The kit according to claim 30, wherein the antibody or antigen-binding fragment thereof binds to the sequence between amino acids 124 to 144 in mature PIGF-2 (SEQ ID NO:6) and/or to the sequence between amino acids 114 to 185 in mature PIGF-3 (SEQ ID NO:7).

33. The kit according to claim 32, wherein the antibody or antigen-binding fragment thereof binds to a P1GF-3 sequence selected from HSPGRQSPDMPGDFRADA (SEQ ID NO:8) and PEEIPRMHPGRNGKKQQRK (SEQ ID NO:9).
